(19) United States
(12) Patent Application Publication
(10) Pub. No.: US 2012/0103715 A1
(43) Pub. Date: May 3, 2012

(54) Cart-A-Kart

(76) Inventor: Albert C. Deslippe, Livonia, MI (US)

(21) Appl. No.: 13/285,336

(22) Filed: Oct. 31, 2011

Related U.S. Application Data
(60) Provisional application No. 61/409,173, filed on Nov. 2, 2010.

(51) Int. Cl. B62D 61/00

(52) U.S. Cl. 180/208

(57) ABSTRACT

An architecture is presented that provides a portable, motorized cart designed for transporting golf equipment or other large items, as well as provides a transportable vehicle. The motorized cart comprises a base unit with wheels, a seat removably secured to the base unit, and a steering mechanism. Furthermore, power controls are included for controlling the motorized cart. Additionally, the cart comprises a securing device for securing an item to the front of the base unit, wherein the item includes golf equipment, yard equipment, shopping bags, etc. Furthermore, the wheels, the foldable seat and the steering mechanism are detachable from the base unit, allowing the motorized cart to be disassembled and stored in a trunk of a car or other vehicle.

### CROSS-REFERENCE

This application claims priority from Provisional Patent Application Ser. No. 61/409,173 filed Nov. 2, 2010.

### BACKGROUND

Golfing can be a strenuous activity. Participants may be required to walk for considerable periods of time while carrying heavy golf equipment. This can be very difficult and tiring, especially for aging or less agile individuals. To alleviate this strain, golfers may choose to use golf carts. However, traditional golf carts can be large, bulky, and cumbersome to use. Also, traditional golf carts cannot be removed from golf courses.

There is a need for a golf cart or motorized cart which is applicable to all users, as opposed to just golfers, and that could be driven right to a user's car and then transported to other locations. The present invention discloses a motorized cart designed for transporting golf equipment or other large items, as well as provides a transportable vehicle. The motorized cart was developed particularly for transporting golf equipment, but could also be used to transport other large items. The disclosed motorized cart comprises components that can easily be disassembled, and thus allows individuals to easily and effortlessly transport golf equipment and other items from one location to another.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a portable, motorized cart designed for transporting golf equipment or other large items, as well as provides a transportable vehicle. The motorized cart comprises a base unit with wheels, a seat removably secured to the base unit, and a steering mechanism. Furthermore, optional power controls can be included for controlling the motorized cart. Additionally, the cart comprises a securing device for securing an item to the front of the base unit, wherein the item includes golf equipment, yard equipment, shopping bags, etc.

Furthermore in the preferred embodiment of the present invention, the motorized cart can be disassembled and stored in a trunk of a car or other vehicle. Specifically, the wheels, the foldable seat and the steering mechanism are detachable from the base unit, allowing the motorized cart to be disassembled and stored. All components of the motorized cart may be quickly assembled and do not require the use of nuts, bolts, or tools. Similarly, the components can be easily disassembled and may fit into the trunk of a car or other vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of a motorized cart, fully assembled and supporting a golf bag in accordance with the disclosed architecture.

FIG. 2 illustrates a side perspective view of the motorized cart, fully assembled and supporting a golf bag in accordance with the disclosed architecture.

FIG. 3 illustrates the motorized cart disassembled and stored in the trunk of a car in accordance with the disclosed architecture.

FIG. 4 illustrates a disassembled motorized cart in accordance with the disclosed architecture.

FIG. 5 illustrates the motorized cart in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a motorized cart or vehicle which is applicable to all users, and that could be driven right to a user's car and then transported to other locations. The motorized cart comprises a base unit with wheels, a seat removably secured to the base unit, and a steering mechanism. Furthermore, the cart may also comprise a securing device for securing an item to the front of the base unit, such as golf equipment or other equipment. The disclosed motorized cart comprises components that can easily be disassembled, and thus allows individuals to easily and effortlessly travel and transport golf equipment and other items from one location to another.

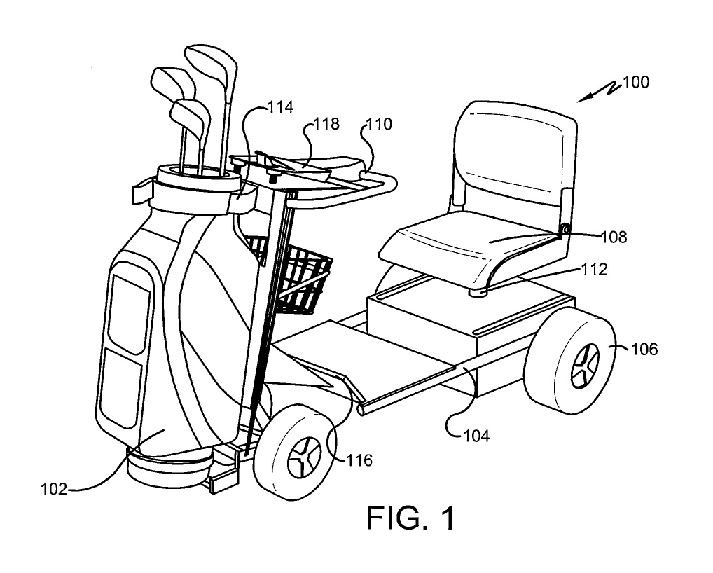

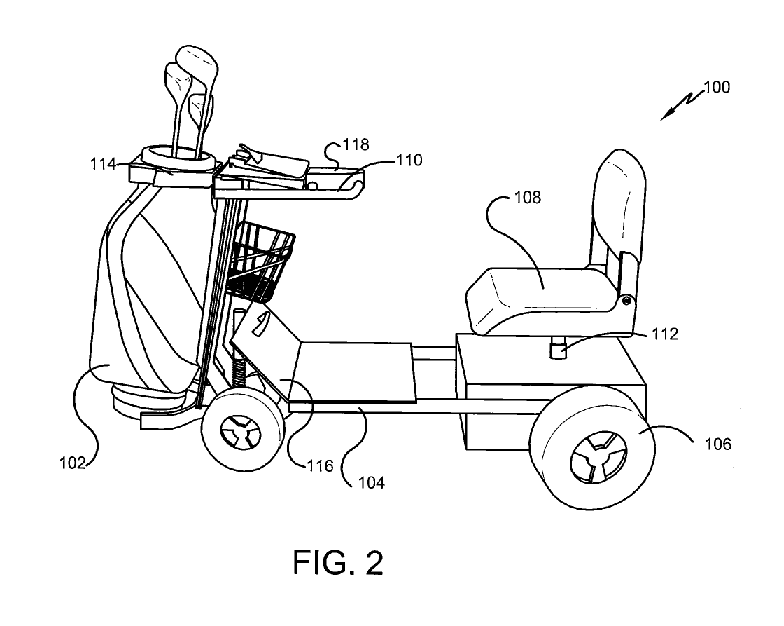

Referring initially to the drawings, FIGS. 1 and 2 illustrate a portable, motorized cart or vehicle 100, fully assembled and supporting a golf bag 102. The motorized cart 100 is designed for transporting golf equipment or other large items, as well as provides a transportable vehicle. The motorized cart 100 comprises a base unit 104 with wheels 106. The base unit 104 is typically a square base unit, but can be any suitable shape or size as is known in the art without affecting the overall concept of the invention. Furthermore, the base unit 104 is generally comprised of a relatively lightweight material such as aluminum, though any other suitable material may be used to manufacture the base unit 104 as is known in the art without affecting the overall concept of the invention. A plurality of wheels 106 can be used to provide the motorized cart 100 with mobility, typically the motorized cart 100 comprises three or four wheels 106. Furthermore, the motorized cart 100 comprises a seat 108 that is removably secured to the base unit 104, and a steering mechanism 110. The seat 108 is typically a foldable seat and is attached to the base unit 104 via a vertical extension component 112. The vertical extension component 112 allows the seat 108 to be adjusted vertically to accommodate users of differing heights and sizes. Typically, the vertical extension component 112 is hydraulic but it is not necessary and the seat 108 can be manually adjusted. Additionally, the seat 108 includes a lever (not shown) that allows the seat 108 to swivel back and forth.

The steering mechanism 110 can be any suitable steering mechanism as is known in the art without affecting the overall concept of the invention. For example, the steering mechanism 110 can be a steering wheel, handle bars, control levers, etc. Furthermore, optional power controls 118 are included for controlling the motorized cart 100. The power controls 118 comprise an off/on switch, forward, reverse, accelerator, brake, etc.

Furthermore, the motorized cart 100 comprises a motor (not shown) which is a 24 volt, heavy duty, transaxle battery that allows the motorized cart 100 to perform various actions, such as move forward, reverse, auto breaking, and free wheeling, etc. The motorized cart 100 also has a back up beeper. Further, the motorized cart 100 comprises an onboard 110 volt to 24 volt battery charger, or any suitable battery charger as is known in the art. Typically, power for the motor comes from two 33 amp, 12 volt batteries, or any other suitable battery as is known in the art. Further, the batteries plug in for recharging, such as via an extension cord.

Additionally, the motorized cart 100 comprises a securing device 114 for securing an item 102 to the front of the base unit 104, wherein the item 102 includes golf equipment, yard equipment, shopping bags, etc. Any suitable item can be secured to the front of the base unit 104 without affecting the overall concept of the invention. The securing device 114 comprises any suitable securing device as is known in the art without affecting the overall concept of the invention, such as a strap, a belt, a clasp, a tie, a cord, etc.

Furthermore, the preferred embodiment of the present invention comprises a foot rest 116 such that a user can rest his or her feet and that provides a user with comfort when operating the motorized cart 100. Typically, the motorized cart 100 is a single-person cart, and is sized to accommodate one person.

The motorized cart 100 is approximately 53 inches long, approximately 29 inches wide, and approximately 39 inches high. The seat height is between approximately 16 inches to 22 inches in height. The motorized cart 100 comprises six main parts, the motor compartment which weighs no more than 60 lbs., the steering column 110 that weighs no more than 20 lbs., the foot rest 116 that weighs no more than 7 lbs., the tires 106 (approximately four tires) that weigh no more than 15 lbs., the seat 108 and extension component 112 that weighs no more than 15 lbs., batteries (approximately two batteries) that weigh no more than 50 lbs., and miscellaneous components that weight no more than 8 lbs. Thus, the motorized cart 100 has a total weight of approximately 175 lbs., and a variable speed of 0-7.5 mph and will travel approximately 15 miles on a flat, dry surface with a 180 lb. load. Further, the measurements and weights as disclosed for the motorized cart 100 and associated components are for example only, and the motorized cart 100 and associated components are not limited to these exact specifications.

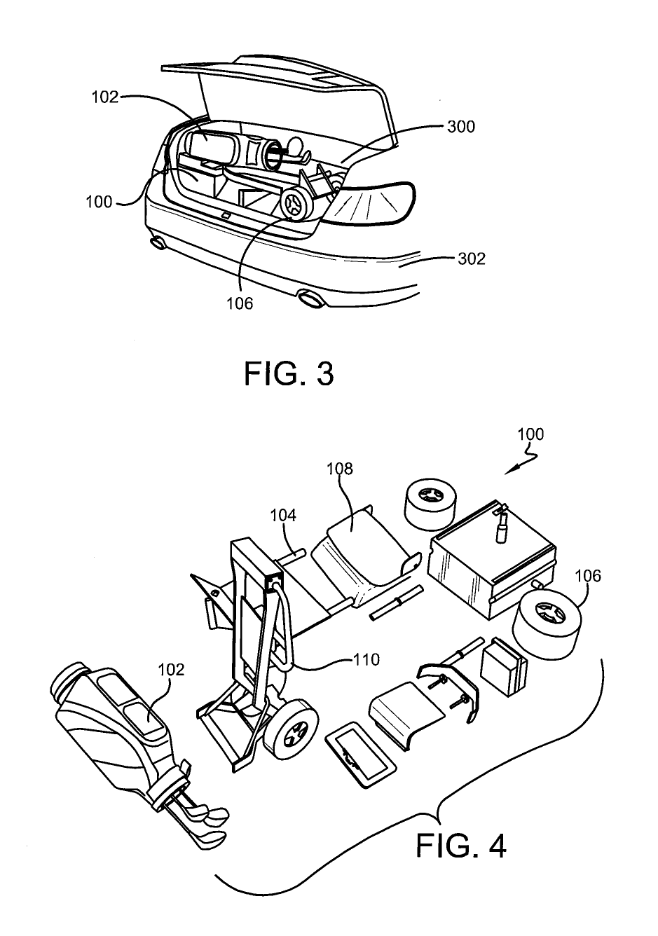

As shown in FIGS. 3 and 4, the motorized cart 100 can be easily disassembled and stored in the trunk 300 of a car 302 or other vehicle. Specifically, the wheels 106, the foldable seat 108 and the steering mechanism 110 are detachable from the base unit 104, allowing the motorized cart 100 to be disassembled and stored. Specifically, the seat 108 is approximately 18 inches by 16 inches folded, for ease of fitting in the trunk of a vehicle. The detachable components, once disassembled, can easily fit into the trunk of most mid-sized cars or other suitable vehicles as is known in the art without affecting the overall concept of the invention. All components of the motorized cart 100 may be quickly assembled and do not require the use of nuts, bolts, or tools. Specifically, the motorized cart 100 is assembled using sleeves, retainer pins, and gravity, such that members and components of the motorized cart 100 are inserted into one another and secured. Similarly, the components can be easily disassembled and may fit into the trunk of a car or other vehicle. Users could use various devices or traditional methods of loading objects to load the components into the trunk of a car, but these devices and methods are outside the scope of the invention.

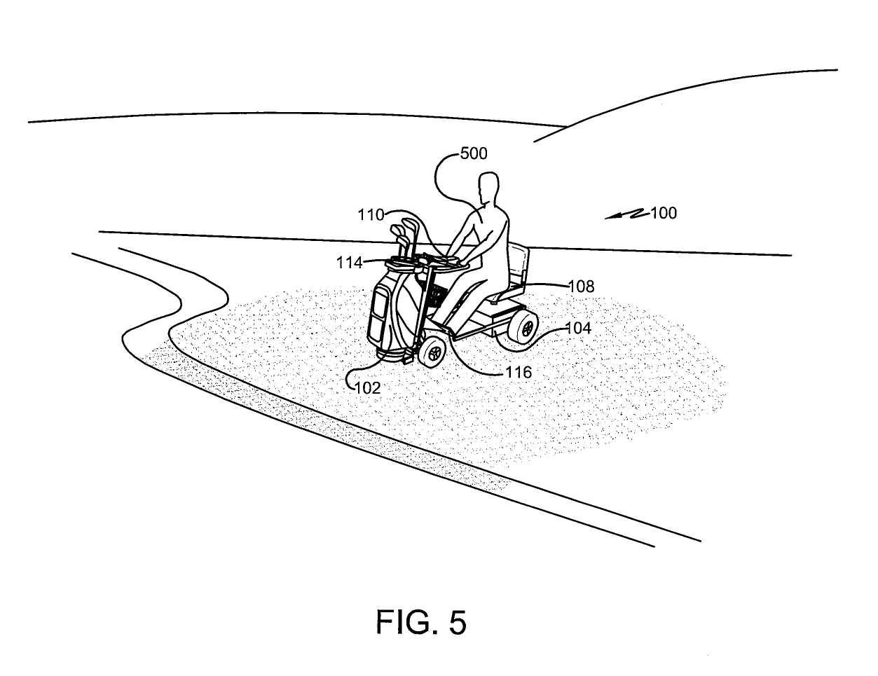

Furthermore, FIG. 5 illustrates the motorized cart 100 in use. A user 500 sits in the seat 108, puts his or her feet on the foot rest 116 and engages the steering mechanism 110 to drive and steer the cart 100. The seat 108 can be adjusted to accommodate the height and size of the user 500, and also allows a user 500 to swivel back and forth. Here, a user's golf bag 102 is secured to the front of the base unit 104 by a securing device 114. The motorized cart 100 can be used to transport golf equipment or other large items, as well as provides a transportable vehicle. Users may benefit from the motorized cart 100 when playing golf, doing yard work, shopping at the mall, or completing other various tasks. The motorized cart 100 can be driven right to a user's car and then transported to other locations. All components of the motorized cart 100 may be quickly assembled and do not require the use of nuts, bolts, or tools. Similarly, the components can be easily disassembled and may fit into the trunk of a car or other vehicle.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable, motorized cart, comprising:
a base unit with wheels;
a seat removably secured to the base unit;
a steering mechanism;
power controls; and
a securing device for securing an item to front of the base unit.

2. The cart of claim 1, wherein the wheels, the seat and the steering mechanism are detachable from the base unit.

3. The cart of claim 2, wherein the cart is disassembled and stored in a trunk of a car.

4. The cart of claim 1, wherein the cart is a single-person cart.

5. The cart of claim 1, wherein the base is a square aluminum base unit.

6. The cart of claim 5, further comprising a hydraulic, vertical extension component that secures the seat to the base unit.

7. The cart of claim 1, further comprising a footrest.

8. The cart of claim 1, wherein the item is a golf bag.

9. The cart of claim 1, wherein the steering mechanism comprises at least one of a steering wheel, handle bars, or control levers.

10. The cart of claim 1, wherein the securing device comprises at least one of a strap, a belt, a clasp, a tie, or a cord.

11. A portable, transportable vehicle, comprising:
a base unit with wheels;
a seat removably secured to the base unit;
a steering wheel;
power controls; and
a securing device for securing an item to front of the base unit; and
wherein the wheels, the seat and the steering wheel are detachable from the base unit, such that the vehicle can be disassembled and stored in a trunk of a car.

12. The vehicle of claim 11, wherein the item is a golf bag.

13. The vehicle of claim 11, further comprising a footrest.

14. The vehicle of claim 11, further comprising a vertical extension component that secures the seat to the base unit and a lever that allows the seat to swivel.

15. The vehicle of claim 11,, wherein the item is at least one shopping bag.

16. A portable, motorized cart for transporting golf equipment, comprising:
a base unit with wheels;
a seat removably secured to the base unit;
a steering wheel;
power controls; and
a securing device for securing golf equipment to front of the base unit.

17. The cart of claim 16, wherein the wheels, the seat and the steering wheel are detachable from the base unit, such that the cart can be disassembled and stored in a trunk of a car.

18. The cart of claim 16, wherein the securing device comprises at least one of a strap, a belt, a clasp, a tie, or a cord.

19. The cart of claim 16, further comprising a vertical extension component that secures the seat to the base unit and a lever that allows the seat to swivel.

20. The cart of claim 16, wherein the cart is a single-person cart.
